(19) United States
(12) Patent Application Publication
(10) Pub. No.: US 2003/0153374 A1
(43) Pub. Date: Aug. 14, 2003

(54) Interactive video racing game

(76) Inventor: Anell Gilmore, Los Angeles, CA (US)

Correspondence Address: ERIK M. ARNHEM, Second Floor, 4250 Wilshire Blvd., Los Angeles, CA, 90010, US

(21) Appl. No.: 10/073,585

(22) Filed: Feb. 12, 2002

(51) Int. Cl. A63F 13/00

(52) U.S. Cl. 463/6

(57) ABSTRACT

An interactive video car racing game can be played on multiple video screens, using individual computers and manual controllers for varying the speed and direction of each car depicted on the video screens. Each player has a video display that includes a split screen presenting two types of race information. One display section presents a reduced scale plan view of a race course and the positions of the race cars on the course. The other display section depicts a magnified ground level view of the race course as seen from the cockpit of selected vehicle.

### FIELD OF THE INVENTION

This invention relates to an interactive video racing game, wherein each game player controls the speed and direction of a simulated vehicle on a simulated race course displayed on a video screen.

### BACKGROUND AND SUMMARY OF THE INVENTION

Various video games have been devised, e.g. games in which a simulated gun is used to shoot multiple targets, or games in which a simulated warrior advances past a maze of obstacles.

The present invention relates to a video game wherein multiple game players manually control simulated racing vehicles on a race course. The game is played on video monitors (or displays) that include split screens. Approximately one half of each video screen displays a small scale plan view of a race course and plural vehicles movable along the race course as the game is being played. The other half of each video screen depicts a magnified ground level view of the race course, as seen from the driver station of a selected vehicle.

In the present game each game player is provided with a manual controller and a video display (monitor). For example, a game involving four players will have four video screens and four manual controllers. The associated computers are electrically connected together, via hard wire connections or phone lines, so that the race course and all of the race vehicles appear on all four of the video displays.

Each game player operates his particular controller to control the speed and direction of one vehicle on the simulated race course. Since all four vehicles are displayed on each video display, each game player can visually determine the location of his particular vehicle in relation to the other vehicles in the race. Thus, each game player can manipulate his vehicle back and forth on the race course, to overtake or outmaneuver other vehicles in the race.

The game can be played by any reasonable number of players, e.g. two players, five players, etc. Each player sits (or stands) in front of an individual video monitor that may be located in the same room as the other video monitors, or in a different geographical location, depending on the way in which the associated computers are linked together for synchronized operation.

In preferred practice of the invention the video game memory includes stored data on various different race course configurations. The players can select any particular race course configuration to play at any given time. For any given game all players play the same course.

### BRIEF DESCRIPTION OF THE DRAWINGS

FIG. 1 depicts a representative split screen video display that can be generated as the game of the present invention is being played.

FIG. 2 is a plan view of a manual controller that can be used by each game player when playing the game according to the present invention.

FIG. 3 schematically illustrates a video game apparatus that can be used in practice of the invention.

### DESCRIPTION OF A PREFERRED EMBODIMENT OF THE INVENTION

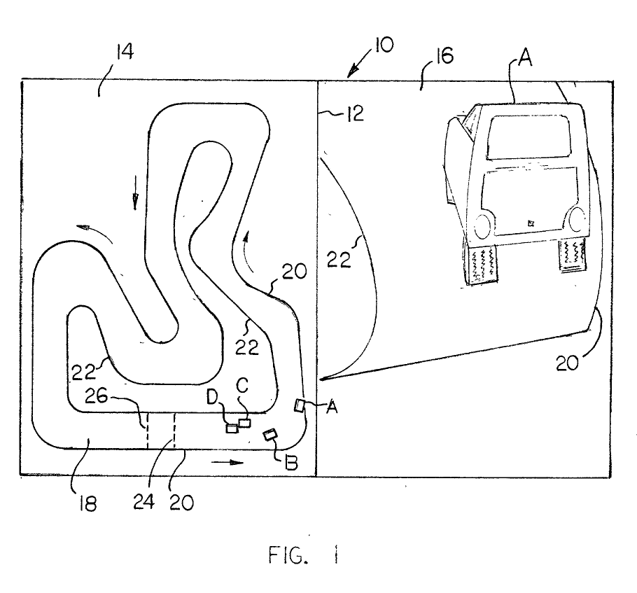

Referring to FIG. 1, there is shown a video display that can be generated while a game of the present invention is being played. The video display is a split screen 10 having a split line 12 that subdivides the screen into a left hand display section 14 and a right hand display section 16.

Display section 14 depicts, on a relatively small scale, a plan view of a race course 18 defined by border (edges) 20 and 22. The course has a start line 24 and a finish line 26. As shown in FIG. 1, there are four race cars A,B,C and D located at different points along the race shortly after the start of the race.

As the game is being played, the four race cars move independently around the race course in a generally counterclockwise direction from start line 24 toward finish line 26. Race car A is momentarily in the lead, while car D is trailing the other three cars. The cars can change places as the game progresses, depending on the manipulative skills of the game players.

The illustrated game has four players, with ech player controlling the speed and direction of one car. For example, one player controls the speed and direction of car A, a second player controls the speed and direction (steering) of car B, and so on.

Car movements are controlled by individual manual controllers that are usually hand-held devices having separate control elements for various different functions, e.g. one control element for starting the race, another control element for steering (direction), and another control element for vehicle speed. FIG. 2 shows one illustrative manual controller 28 that can be employed in practice of the invention.

The controller shown in FIG. 2 is a commercially available device manufactured by Microsoft Corporation of Redmond, Calif. under the designation SINDWINDER. The controller includes two handles 30,30 that the player can grasp with his left and right hands while viewing the video display (screen). Various control buttons 33 are located on the controller upper surface. By depressing an individual button (element) it is possible to achieve a particular control function useful in playing the game of the present invention.

Still referring to FIG. 2, controller 28 has a depressible pad 34 that is useful for controlling the direction of a selected race car A,B,C or D (FIG. 1). The player places the thumb of his left hand over pad 34, and applies thumb pressure on a selected area 36 (or between selected areas 36), to steer the vehicle on the video display screen.

The speed of a particular vehicle A,B,C or D can be controlled by a manual trigger 38 located on the undersurface of controller 28. The player grasps the rightmost handle 30 with three fingers, while pressing his first finger against the trigger 38 surface to speed a selected vehicle A,B,C or D. Reducing the pressure on the trigger surface reduces the velocity of the selected vehicle.

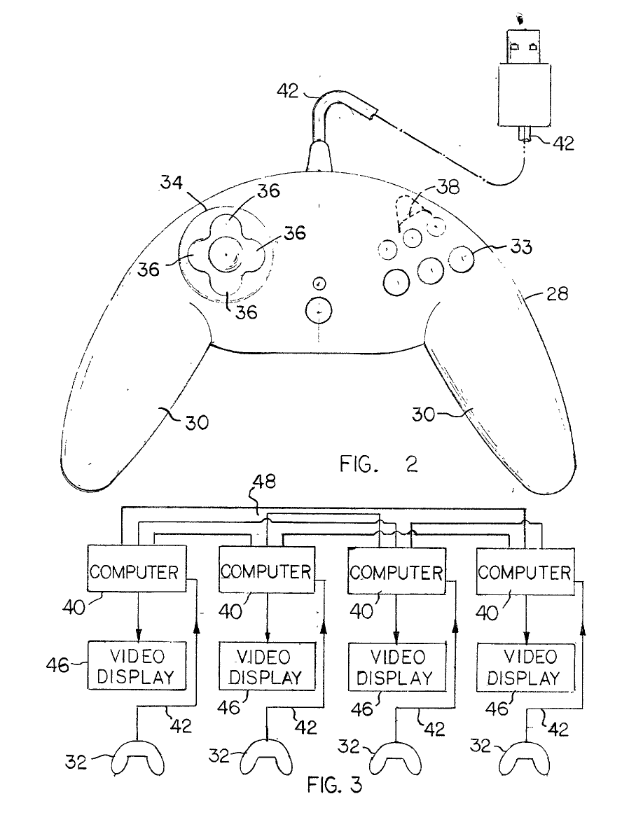

Each controller 32 is connectable to an associated computer 40 by means of an electrical cord 42. The cord has an electrical plug element 44 that plugs into one of the USB ports on the computer to deliver operating instructions to the computer. As shown in FIG. 3, there are four computers 40. Ech computer receives instructions from an associated controller 32 via an electrical cord 42. Each computer output is delivered to n associated video monitor 46 which has a split screen display of the type shown in FIG. 1.

The various computers 40 are connected for joint simultaneous operation by hardwire connections or by modem phone lines. The computer connections are referenced by numeral 48 in FIG. 3. Each computer includes a central processing unit, memory, and operating instructions. Part of the memory can be a computer disk containing memorized data necessary for playing the video racing game, i.e. data for displaying the pictures on split screen 10 (FIG. 1). As an ancillary feature, sound cards having pre-recorded sounds (music, etc.) can be used in each computer to provide sound along with the pictorial display. The sounds can vary from one computer to another, in accordance with individual preference.

Referring to FIG. 1, the right hand display section 16 of the split screen depicts a magnified ground level view of the race course, as seen from the driver station of a selected vehicle. In FIG. 1, the view is taken forwardly from the driver cockpit of vehicle B. The view shows the rear end of vehicle A as the vehicle is negotiating a turning maneuver at a corner of the race track.

The display section 16 depicted in FIG. 1 represents the view that a driver of vehicle B might have on an actual race course. The computer memory for the associated computer comprises a program that correlates the image on display section 16 with the position of the corresponding vehicle in display section 14. The player having the controller for vehicle B is able to view display section 14 to ascertain the position of vehicle B relative to the other vehicles; at the same time the player is able to view display section 16 to obtain understanding of the actual race course contouring (banks and turns), as well as relative velocities of his vehicle and the vehicle he is attempting to overtake, e.g. vehicle A.

Prior to playing a game the players will select a race course, usually by mutual agreement. A menu of available race courses can be displayed on each screen 10, whereupon one of the players can operate a control button on his controller 32 to bring the appropriate race course onto display section 14 of each video monitor. Each player will then select a particular ace car as his car for the race. Initially, all race cars will be displayed in position at the start line 24 of the race course.

As the game is played, each player will operate his controller to advance his vehicle along the race course. As previously noted, the player can actuate trigger 38 and steering pad 34 on his controller to control the velocity and direction of his vehicle. The other players will, at the same time, be operating their controllers to advance their respective vehicles along the race course. The computers are linked so that the left hand display section 14 on each video display is the same; each player has the same visual information concerning the relative positions of the vehicles on the race course.

Each computer memory contains a program that correlates the image on display section 16 with the location of the corresponding vehicle in display section 14. Display section 16 will show a different image for each player. For example, display section 16 for vehicle A will show a clear section of the race course (devoid of other vehicles). Display section 16 for vehicle B will show the rear end of vehicle A. Display section 16 for vehicle C will show vehicles A and B (i.e. as seen from the cockpit of vehicle C). The display sections 16 on the various video displays will change as the game progresses.

It may be desirable to penalize the players for erratic or careless driving. In one scenario each computer memory can include a program whereby the controlled vehicle is momentarily decelerated (stopped) whenever that vehicle strikes the rear end area of another vehicle, or whenever that vehicle crosses one of the race course edges 20 or 22.

In FIG. 1, vehicle A is shown crossing (or intersecting) edge 20 of the race course. The computer memory for vehicle A will momentarily stop vehicle A, so as to penalize the player controlling that particular vehicle; an override signal will be generated by trigger 38 for the vehicle A controller.

Still referring to FIG. 1, vehicle D is shown to be in contact with the rear end of vehicle C. The computer memory will generate an override signal to momentarily stop, or decelerate, vehicle D, thereby penalizing the player controlling vehicle D.

The described video game requires a certain degree of skill on the part of each player, since each player is penalized for erratic driving and inability to keep pace with the other vehicles in the race.

In order to illustrate some highlights of the game: A player accumulates winnings in the game he/she will then be able to modify and improve on the appearance and quality of the car. Modifying one's car may involve many different improvements, such as painting the car, upholstery and hydraulic suspensions, etc. Obviously, if one invests (from winnings in the game) in quality parts or items of the car it will cost more money, but he/she will also improve the chances of performing better and eventually win the game.

As an example, if you acquire expensive hydraulic equipment, one would be able to do flipping and hopping in various manners and tricks with the car. For that purpose a Super Pump needs to be installed and the player can enter into hydraulic competition with other participants in the game. The more money that one spends on the hydraulic equipment, the better one will be able to do a variety of tricks with the car.

There will be an original Gangster (O.G.) Low Riding game where races will be held around major cruising spots. Here, one will be able to pick a car among 50 stock Low Riders. When one wins any prize money he/she can purchase new parts for the car and customize it, as one likes, such as tires, brakes, tints, mufflers, etc. to improve one's chances of subsequently winning more money.

The game can be played by a relatively small number of players, usually six or less. However clubs or associations can be formed to permit a large number of players to participate in different groups (i.e. different car races). For example if seven different races (involving six players in each race) were to be held at approximately the same time, it would be possible for a relatively great number of people to compete. Winners of preliminary races could meet to determine an overall winner.

An association or club, with sufficient members, could be formed to widen the scope of competition and provide prizes for the winning competitors. Race results and ancillary information relative to car performance, car styling, and car accessories could be exchanged between club members, using the internet and/or club magazines.

As an expanded practice of the invention, the car races could involve a range of different type vehicles, e.g. stock cars, so-called classic cars, police cars, Indianapolis 500 race cars, modified hot rods, street cars, etc. Information on various car types and accessories could be provided in the club magazine, along with the above-described race results.

The described interactive video racing game is conducive to participation by relatively large numbers of players (e.g. in a club or association), since the same race course can be played on a repetitive basis over the internet to produce several winners at various different locations.

The Following List Contains an Incomplete Summary of Features Usable as Part of the Video Game According to the Invention

1. Races may be held at different spots around the world.

2. Minimum bet on games with $300:—

3. Win prize money.

4. Purchase parts for one's car from prize money, such as, tires mufflers, hydraulics

5. Fifty courses to choose from.

6. Pay for damages to car out of prize money.

7. Showcase your car in a catalog with cars on the internet.

8. Put your car in a garage.

9. Choose between vertical and horizontal split screens.

10. Choose between cheap components and expensive components.

11. When buying cheap equipment, damage to car may occur. pay for repairs out of accumulated money.

12. Change the color and styling of the car.

13. Choosing different license plates.

14. Live footage of a real competition.

15. Demonstrate car hopping abilities. 20 second time limit).

16. Race on internet. Get ranked.

17. Buy/sell over the internet.

18. People can vote for best customized car.

19. Music played high or low volume, depending on geographical area or cost of radio.

20. Create different characters (girls of various nationalities).

21. Winning cars are publicized in a magazine.

22. Police chases with vehicle impounding and penalties.

23. Race for “cool chips” to buy accessories.

24. Buy car television or DVD players. View Low Rider video.

25. Once a week opportunity to buy a customized bike.

What is Claimed:

1. An interactive video racing game, comprising:
a computer for each game player.
means linking the computers for synchronized operation; and
a manual controller for each game player, each said manual controller being electrically connected to an associated computer for delivering instructions thereto, and
a video display associated with each said computer;
each said computer comprising a central processing unit, memory and operating system;
each said video display comprising a split screen that includes a first display section
presenting a reduced scale plan view of a race course and plural vehicles movable along said race course, and a second display section depicting a magnified ground level view of the race course as seen from the driver station of a selected vehicle;
each said manual controller having manual means for varying the speed and direction of a selected vehicle on the associated first display section;
each said computer memory comprising a program that correlates the image on the associated second display section with the position of the corresponding vehicle in the first display section:
said computer memories being linked so that all game vehicles are continually displayed on the first display section of each video display.

2. The video racing game of claim 1, wherein the race course depicted in each said first display section has two edge boundaries; each said computer memory comprising a program that momentarily decelerates the associated vehicle when that vehicle contacts either edge boundary.

3. The video racing game of claim 1, wherein each said computer memory comprises a program that momentarily decelerates the associated vehicle when that vehicle contacts the rear portion of another vehicle on the race course.

4. The video racing game of claim 1, wherein each said computer memory includes stored data on various different race courses; each said controller comprising means for selecting a race course from the stored data for display on the first display section of each said video display, said game being subject to rewards and penalties to winning and failing players, respectively;
